(19) United States
(12) Patent Application Publication
(10) Pub. No.: US 2003/0079389 A1
(43) Pub. Date: May 1, 2003

(54) Hand-held signboard

(76) Inventor: Joel Chandler Eberly, Summerville, SC (US)

Correspondence Address: KATHLEEN M HARLESTON, THE HARLESTON LAW FIRM, 909 TALL PINE ROAD, MT PLEASANT, SC, 29464

(21) Appl. No.: 10/039,875

(22) Filed: Oct. 26, 2001

(51) Int. Cl. G09F 7/00; G09F 19/00; G09F 21/02

(52) U.S. Cl. 40/586; 40/492; 40/533

(57) ABSTRACT

A hand-held message board for displaying messages, includes: (a) a generally rigid dry erase board having an erasable front writing surface; (b) a means of holding the message board by hand; (c) separate pages, each movably affixed to an upper edge of the dry erase board, each page having a pre-printed message or sign on it; and (d) fastener means for removably attaching the pages to the upper edge of the dry erase board; wherein the individual pages are flippable between the front surface and the rear surface of the dry erase board.

### BACKGROUND OF THE INVENTION

1. Technical Field

The present device is a hand-held signboard useful for displaying a variety of pre-printed messages and creating, displaying, and changing spontaneous messages in a variety of situations.

2. Background Information

Existing inventions include a hand-held traffic signaling device, an executable sign for traffic emergencies, a hanging sign for disabled motorists, and a holder for display cards. These devices allow for the display of preprinted messages with a hand-held device, and may be useful for traffic emergencies, disabled motorists, road workers, and the like. They may also be useful to users of flash cards. There is nothing of this type currently available, though, that allows a user to quickly create his or her own message that also is easily erasable and easy to hold and display in one hand, or that allows the user to create his or her own preprinted messages, or to choose between quickly creating his own message on the spot and displaying a preprinted message.

### BRIEF SUMMARY OF THE INVENTION

The present invention is a hand-held message board for displaying messages, comprising:

(a) a generally rigid dry erase board having an erasable front writing surface;

(b) a means of holding the message board by hand;

(c) a plurality of separate pages, each movably affixed to an upper edge of the dry erase board, each page having a pre-printed message or sign thereon; and

(d) means for removably attaching the pages to the upper edge of the dry erase board;

wherein the individual pages are flippable from the front surface of the dry erase board to a rear surface of the dry erase board, and from the rear surface to the front surface of the dry erase board.

The hand-held message board of the present invention has flip-over message sheets and a dry erase board for creating and displaying visual messages. A preferred embodiment of this message board includes, generally, a rigid board with a dry-erasable surface on a front surface; one, two or three loose-leaf-type rings attached to its upper edge; a series of clear plastic loose-leaf sheet protectors attached by means of the rings; a hand strap affixed to a rear surface for easily holding and displaying the message board; and a dry-erase marker and eraser attached by means of hook and loop fastener to the rear surface. The message board of the present invention can be easily used to hold and display messages either created on paper and inserted into the clear plastic sheet protectors, or written with a dry erase marker onto the dry erase front surface of the board.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a front elevational view of a message board according to the present invention;

FIG. 2 is a rear elevational view of the message board according to FIG. 1;

FIG. 3 is a plan view of a message board according to the present invention, showing the relative positions of a dry erase board, rings, marker, and several pages;

FIG. 4 is a rear perspective view of a message board according to the present invention, showing a hand strap, marker, rings, and several pages; and

FIG. 5 is a front perspective view of a message board according to the present invention; and

FIG. 6 is a front elevational view of a message board according to the present invention, showing a snap-tight cover.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

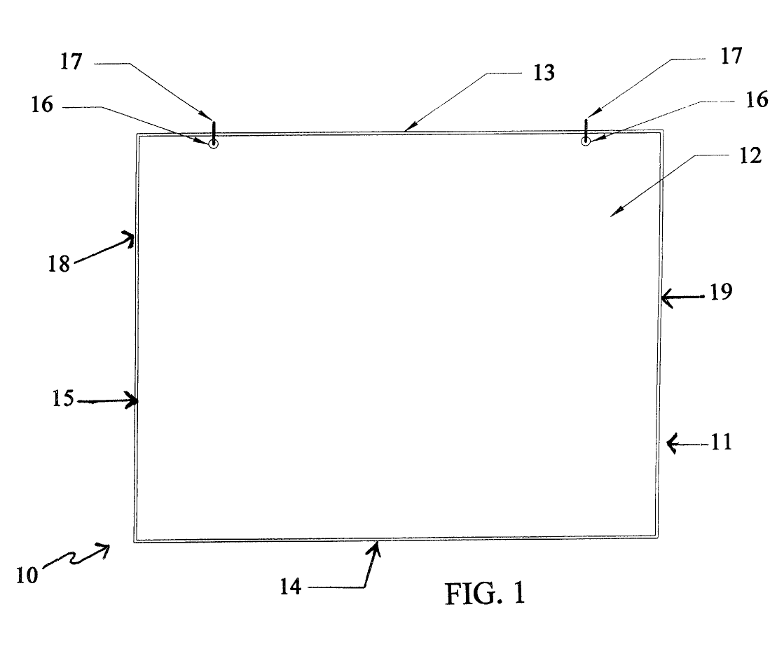

Turning to FIG. 1, a message board, or signboard, according to the present invention is useful for holding up handwritten or prepared messages in one vehicle in order to communicate with occupants of another vehicle. This hand-held message board, generally referred to herein as 10, includes: a generally rectangular dry erase board 11 having an erasable front writing surface 12, which is shown in FIG. 1, and a rear surface 20, which is preferably a non-writing surface. The base of the dry erase board 11 is made of a generally rigid, lightweight material, such as particle board, although any other suitable material could be used as well. In this preferred embodiment, dimensions of approximately 9 inches by 12 inches would be appropriate, although the precise measurement is not essential to the invention; however, the dry erase board 11 is preferably of a size slightly larger than an ordinary letter-sized sheet of paper, so that it will easily accommodate plastic sheet protectors sized for 8 ½ inch by 11 inch paper without excessive overhang at the edges of the message board. The front surface 12 of the dry erase board 11 is an erasable writing surface.

Along all four edges of the perimeter of the dry erase board 11 may be affixed a border, or bumper 15, which is preferably made of rubber or plastic, to provide a smooth edge. When in use in a vehicle, it is common for the message board 10 to be bumped around the interior of the vehicle. The message board 10 is generally small enough to be stored in an interior compartment of the vehicle, or in a pocket on the back of a seat in the vehicle, for example. The message board may be used, for example, by vehicle drivers or occupants in traffic, fans at sporting events, drivers picking up passengers at airports, protesters, beggars, stores requiring simple temporary message displays, and anyone else requiring a convenient, portable, compact, lightweight, inexpensive means of visual display.

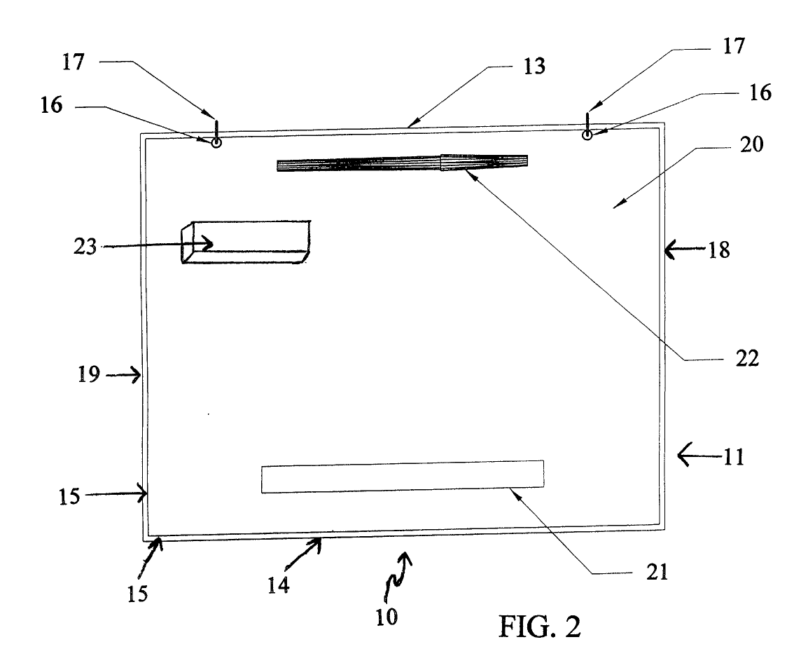

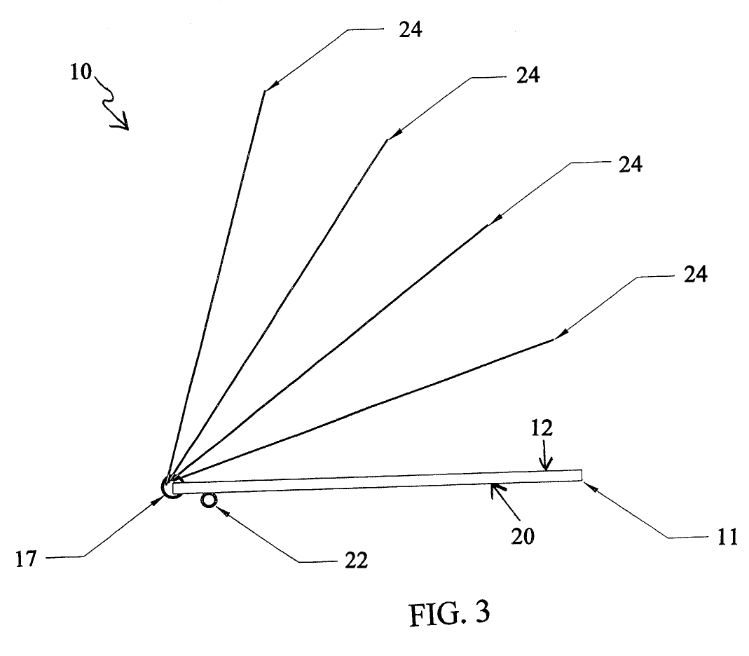

Referring to FIG. 1, FIG. 2, and FIG. 3, holes 16 in the upper portion of the dry erase board 11 near one edge of the longer dimension, which is denominated the upper edge 13, are positioned so as to align with corresponding apertures in an upper portion of the pages 24, which are preferably 8 ½ by 11 inch loose-leaf paper in sheet covers. Fasteners 17, such as loose-leaf rings, are attached to the dry erase board 11 through the holes 16. The fasteners 17 are preferably of a type that can be easily opened and closed, allowing the insertion and removal of loose-leaf sheet covers. Loose-leaf rings can be used, although other fasteners may be found that will work equally well. FIG. 1 and FIG. 2 show two ring fasteners; three spaced-apart ring fasteners could also be used, but are not necessary to the invention. Each sheet of loose-leaf paper is removably enclosed within a plastic sheet protector 30. The sheet protectors 30 preferably are clear and also have corresponding holes along one side of each sheet protector. The sheet protectors 30 are removably attachable to the dry erase board through the same fasteners 17.

Referring to FIG. 2, a hand strap 21 is attached to the rear surface 20 of the dry erase board 11 in a horizontal alignment, that is, parallel to the upper 13 and lower 14 edges, those being the longer dimensions of the preferred rectangular shape and centered midway between the left 18 (when viewed from the front) and right 19 (also when viewed from the front) edges of the dry erase board 11. Each end of the hand strap 21 is attached to the dry erase board 11 by glue, staples, rivets, or any other suitable means, and the major portion of the hand strap 21 between the attached ends is thus unattached, allowing the user to slip his or her flattened hand, between the strap 21 and the rear surface, with the palm against the dry erase board 11. The hand strap 21 is preferably about six to seven inches in length, with approximately the middle five inches unattached to the dry erase board 11 and thus free for the user to insert his or her hand. In the preferred embodiment, the hand strap 21 is positioned near the lower edge 14, approximately 20% of the vertical distance from the lower edge 14 to the upper edge 13; it may be attached higher as long as it is in a position that allows for the user to conveniently balance and control the dry erase board 11 on the hand. This will generally require attachment of the hand strap 21 no higher than the middle of the dry erase board 11. The hand strap 21 may be of elastic or other material that will provide reasonable comfort to the user and allow some flexibility for different hand sizes, while still offering a snug fit.

Referring again to FIG. 2, a dry erase marker 22 is shown attached to the rear surface 20 of the dry erase board 11, near the upper edge 13 in the embodiment shown in FIGS. 1 and 2, although a different placement could also be used on the rear surface 20, or even on the front surface 12 of the dry erase board 11. In the preferred embodiment, the marker 22 is attached to the rear surface 20 of the dry erase board 11 by means of hook and loop fastener. Other means of attachment could also be used, such as a permanently affixed loop through which the marker 22 could be inserted. An eraser 23 can also be attached to the rear surface 20 of the dry erase board 11 by hook and loop fastener in a manner similar to the marker 22, which can then be used to erase the message on the front surface 12.

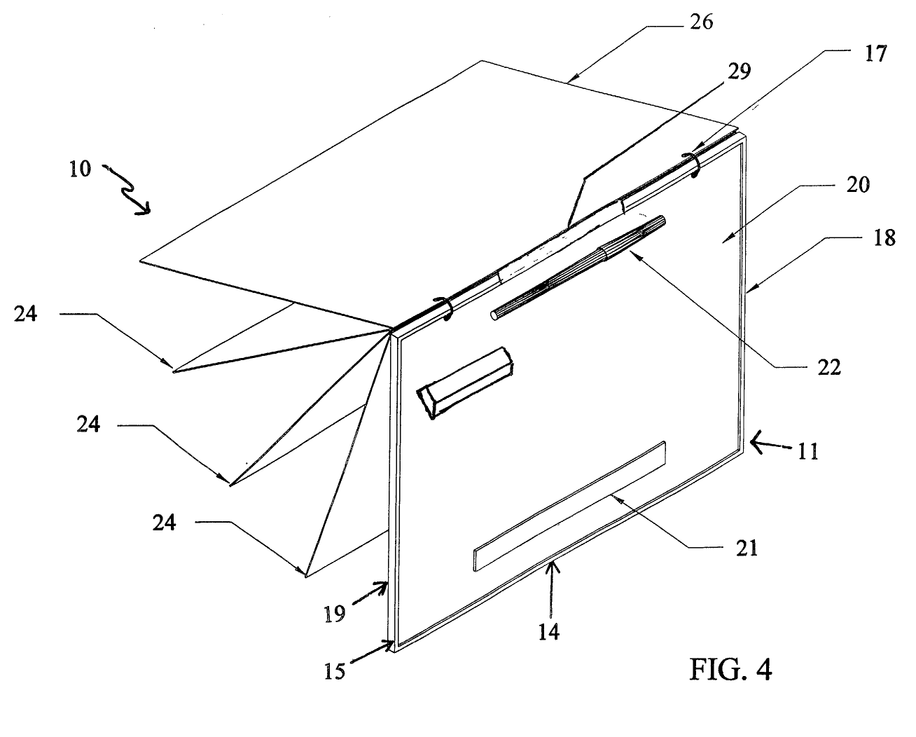

Referring to FIG. 3 and FIG. 4, a number of loose-leaf pages 24 may be inserted by means of the rings or other fasteners 17. The user may also insert loose-leaf paper sheets without sheet protectors 30, or any other sheets of similar size with holes punched along one edge. Referring to FIGS. 3 and 4, only one page 24 is displayed at a time from the front view of the dry erase board 11; thus, only one message is projected to a viewer.

Continuing with FIG. 3 and FIG. 4, the pages 24 may be flipped over from the front surface 12 of the dry erase board 11 to the rear surface 20, and back again, so that the user may easily choose which message to display. Preferably, each page 24 has a different message on each side of the page. Typed messages could include, for example, “Help” written in large red letters on a yellow page, “Go Team!” “God Bless”, “Nice Car”, etc. Alternatively, the user may also flip all pages 24 to the back and display the writing surface 12 of the dry erase board 11 with a message that he or she writes using the dry erase marker 22. If the user does not have time, for example, to hand write a message on the board, he or she chooses one of the pre-printed signs. Since the signs/messages are detachable and inexpensive, they can be changed as often as desired. The messages can be typed on a typewriter or personal computer and printed out. Drivers are discouraged from using the message board 10 while driving a motor vehicle.

As shown in FIG. 4, in one embodiment, the message board 10 may have a movable, rigid, transparent cover 26, which fits down over the pages 24 below it. In FIG. 4, the movable cover 26 has two circular holes at the top by which is movably attached to the ring fasteners 17. This movable cover 26 protects the pages 24 when the message board 10 is not in use. When the message board 10 is in use, the movable, transparent cover 26 reveals the message on the uppermost page 24 beneath it, or the movable cover 26 can be flipped behind the message board like another page, where it is out of the way of the user and where it adds sturdiness to the message board 10.

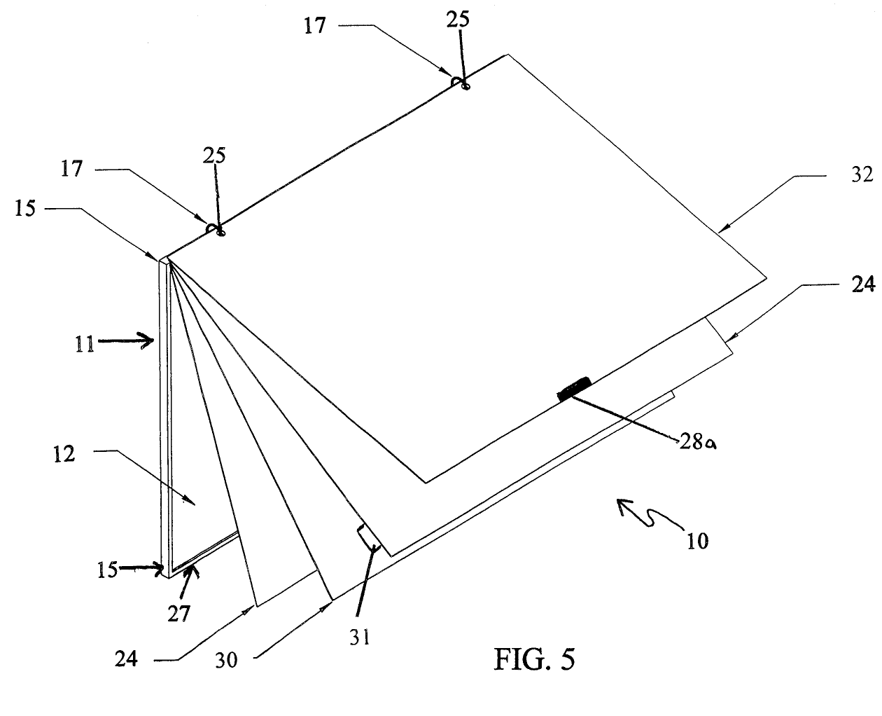

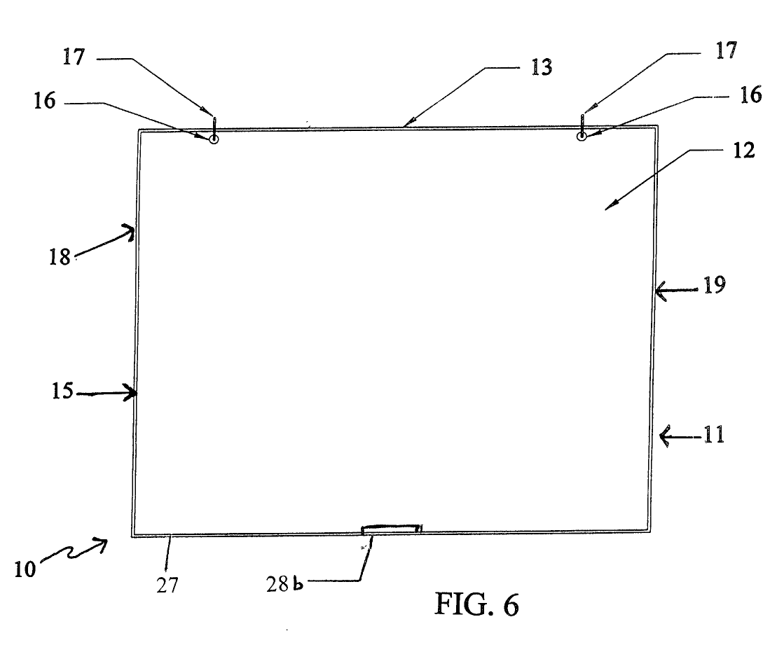

Turning to FIG. 5, an alternate embodiment of the message board 10 includes a rigid, snap-lock cover 32 which fits down over the pages 24 below it and snaps into a snap mechanism attached to the bottom member 27 of the dry erase board frame. The cover and dry erase board act as a case, which protects the pages 24 and the front surface 20 of the board when the message board 10 is not in use. The message board thus forms a box for convenient storage. When the message board 10 is in use, though, the rigid cover 32 can be flipped behind the message board where it is out of the way of the user and where it adds sturdiness to the message board. The rigid cover 32 can also be flipped back to a partially open position (forming approximately a 45 degree angle with the dry erase board), so that the message board 10 can be propped on a flat surface, like a pup tent or standing picture frame. The snap-lock cover 26 and/or a bottom member 27 of the board's frame may have a locking mechanism 28, so that a snap-lock member 28a on the rigid cover 32, as shown in FIG. 5, snaps down into a corresponding snap-lock member 28b on the board's frame, as shown in FIG. 6.

Continuing with FIG. 5, the pages 24 can be marked by some tactile means such as a tab 31 along the side of the page, so that the pages/messages can be told apart by touch without visually distracting the user. The message board 10 may also have a carry handle 29 attached to the upper edge of the dry erase board 11, as shown in FIG. 4.

In sum, a preferred embodiment of the message board 10 includes, first: (a) a generally rigid dry erase board 11 having an erasable front writing surface 12 and a rear, non-writing surface 20. The dry erase board 11 comprises at least one hole and preferably two or three. The dry erase board 11 preferably has a thin rubber or plastic bumper 15, affixed along the perimeter of the dry erase board 11.

Secondly, the message board 10 includes: (b) a generally centered, horizontally aligned, flexible hand strap 21 having two opposite ends, each of which is attached to the rear, non-writing surface 20 of the dry erase board 11. The hand strap 21 is preferably elastic and in the lower third of the rear surface 20 of the dry erase board 11, and parallel to the lower edge of the dry erase board 11. Also removably attachable to the rear surface 20 of the dry erase board 11 are: a dry eraser 23, and a pen or marker 22 that is compatible with use on a dry erase board. The marker 22 and eraser 23 are each most preferably attached to the rear surface 20 by at least one strip of hook and loop fastener.

The message board 10 further includes: (c) a number of separate pages 24, preferably one to ten pages, each movably affixed to an edge of the dry erase board 11; and (d) means 17 for removably attaching the pages 24 to the dry erase board 11. Each page 24 has a pre-printed message or sign on it. The individual pages 24 can be flipped from the front surface 12 of the dry erase board 11 to the rear surface 20 of the dry erase board 11, and from the rear surface 20 to the front surface 12, affording a variety of prepared messages. The means for removably attaching the pages to the dry erase board 11 is preferably at least one openable fastener 17 that passes through the circular apertures 25 in the pages 24 and the hole 16 in the dry erase board 11. More preferably, the fasteners 17 are rings and the pages 24 are sheets of loose-leaf paper, each sheet enclosed in a plastic sheet protector 30. The pages 24 each comprise at least one circular aperture 25, and preferably two along the upper side of the board. The dry erase board 11 preferably has about two spaced-apart holes 16 in an upper portion of the dry erase board 11. The holes 16 in the board 11 are aligned with the corresponding circular apertures 25 in the upper portion of the pages 24.

From the foregoing it can be realized that the described device of the present invention may be easily and conveniently utilized as a signboard for displaying a variety of visual messages, whether in words or pictures. The user may create a number of messages on ordinary paper and insert them into the sheet covers for ready availability, and may also use the dry erase board to create spontaneous messages or images, which can then be erased from the dry erase board for reuse. Because of the compact and lightweight construction, the user can easily carry and hold the message board and can flip from one message to another by a quick rotation of the hand. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 hand-held message board

11 dry erase board

12 front, writing surface of dry erase board

13 upper edge of dry erase board

14 lower edge of dry erase board

15 bumper

16 hole in dry erase board

17 fastener

18 left edge of dry erase board

19 right edge of dry erase board

20 rear surface

21 hand strap

22 marker

23 eraser

24 page

25 aperture in page

26 loose cover

27 bottom member of frame

28 locking mechanism

29 handle

30 sheet protector

31 tab 32 snap-lock rigid cover

What is claimed is:

1. A hand-held message board for displaying messages, the message board comprising:
(a) a generally rigid dry erase board having an erasable front writing surface;
(b) a means of holding the message board by hand;
(c) a plurality of separate pages, each movably affixed to an upper edge of the dry erase board, each page having a pre-printed message or sign thereon; and
(d) fastener means for removably attaching the pages to the upper edge of the dry erase board;
wherein the individual pages are flippable from the front surface of the dry erase board to a rear surface of the dry erase board, and from the rear surface to the front surface of the dry erase board.

2. A message board according to claim 1, wherein the dry erase board comprises at least one hole, the pages each comprise at least one aperture aligned with the hole in the dry erase board, and the fastener means comprises at least one openable ring fastener that passes through the apertures in each of the pages and the hole in the dry erase board.

3. A message board according to claim 2, wherein the pages are disposable loose-leaf paper, each sheet of loose-leaf paper being removably enclosed within a plastic sheet protector.

4. A message board according to claim 2, further comprising a transparent, sturdy, plastic cover the same size as the pages, the cover being movably affixed to an upper edge of the dry erase board.

5. A message board according to claim 2, wherein the dry erase board comprises at least two of the holes in an upper portion of the dry erase board, the holes in the dry erase board being aligned with the corresponding apertures along one side of the pages.

6. A message board according to claim 1, wherein the means of holding the message board is a generally centered, horizontally aligned, flexible hand strap having two opposite ends, each of which is attached to the rear surface of the dry erase board.

7. A message board according to claim 3, further comprising a dry eraser removably attachable to the rear surface of the dry erase board.

8. A message board according to claim 4, wherein the dry eraser is removably attached to the dry erase board by at least one strip of hook and loop fastener.

9. A message board according to claim 6, wherein the hand strap is elastic and attached to the lower third of the rear surface of the dry erase board, the hand strap being parallel to a lower edge of the dry erase board.

10. A message board according to claim 2, and further comprising a rubber or plastic bumper affixed to the perimeter of the dry erase board.

11. A message board according to claim 10, wherein each page comprises a different message written or typed onto the page.

12. A message board according to claim 9, further comprising a dry erase board compatible marker, the marker being removably affixable to the rear surface of the dry erase board.

13. A message board according to claim 9, further comprising a dry erase board compatible eraser, the eraser being removably affixable to the rear surface of the dry erase board.

14. A message board according to claim 9, further comprising a movable, rigid, transparent cover, which fits down over the pages below it; the movable cover having two holes at the top by which is movably attached to the ring fasteners.

15. A message board according to claim 9, further comprising a rigid, snap-lock cover which fits down over the pages below it and snaps into a snap mechanism attached to the bottom member of the dry erase board frame.

16. A message board according to claim 1, further comprising a snap-lock cover movably attached along an upper one of its sides to an upper edge of the dry erase board, the message board comprising a locking mechanism on an opposite side, the cover fitting closely into a frame of the dry erase board, the cover being temporarily attachable to the dry erase board by the locking mechanism.

17. A message board according to claim 9, wherein a snap-lock member on the rigid cover, snaps down into a corresponding snap-lock member on the board's frame

18. A message board according to claim 9, further comprising at least one tab along a side of one of the pages, so that pages and messages can be told apart by touch.

19. A message board according to claim 9, further comprising a carry handle.

20. A method for displaying messages on a message board, comprising the steps of:
a) creating, typing, and printing at least one message on at least one sheet of paper;
b) clasping the sheets of paper onto at least one ring fastener of a message board;
c) selecting a message from the pre-printed sheets;
d) flipping the sheets of paper over to the back of the message board until the desired message page is reached;
e) displaying the message board for a viewer to see.

21. A method according to claim 20, further comprising the step of: a1) before step a), unsnapping a rigid cover from the front surface of the message board, and flipping the cover to the back of the message board.

22. A method according to claim 20, further comprising the step of: f) after step e), pushing the cover down onto the locking mechanism until the cover snaps shut.
